(19) United States
(12) Patent Application Publication
(10) Pub. No.: US 2002/0021699 A1
(43) Pub. Date: Feb. 21, 2002

(54) Network device and method for controling quality of service

(76) Inventor: Shih-Pin Hsiao, Taipei (TW)

Correspondence Address: BIRCH STEWART KOLASCH & BIRCH, PO BOX 747, FALLS CHURCH, VA, 22040-0747, US

(21) Appl. No.: 09/885,098

(22) Filed: Jun. 21, 2001

(30) Foreign Application Priority Data
Aug. 15, 2000 (TW) 89118918

(51) Int. Cl. H04L 12/28

(52) U.S. Cl. 370/395.21; 370/419

(57) ABSTRACT

A network device for controlling quality of service, which includes a first connection port, a second connection port, a third connection port, and a service quality control element. The first connection port receives first class signals. The second connection port receives second class signals that require a higher service quality than the first class ones. The service quality control element receives the first class signals and the second class signals transmitted from the first connection port and the second connection port and let the second class signals pass first when both the first class signals and the second class signals arrive at the same time. The third connection port outputs the first class signals and the second class signals from the network device with the service quality control. The invention also discloses a method for controlling quality of service.

### BACKGROUND OF THE INVENTION

1. Field of Invention

The invention relates to a network device and method for controlling the quality of service in transmitting video or voice signals along with other signals at the same time on a network.

2. Related Art

Along with the progress in network technologies, it is very common to transmit voice or video signals on a network. However, if there is any delay in transmitting the video or voice signals, discontinuity will appear on the screen or in the delivered voice. Therefore, when transmitting video or voice signals at the same time with other signals on a network, QoS (Quality of Service) control needs to be taken care of properly.

For example, network telephony needs to convert the analogue voice signals of the telephone into digital voice data packets and send them to a target place through a wide area network. However, when the digital voice data packets are transmitted along with other usual data packets in a LAN (Local Area Network), the limitations of the network bandwidth often causes delays in the digital voice data packet transmissions so that the receiver receives discontinuous voice signals.

Therefore, how to improve the QoS in transmitting video or voice signals on a network has become an important subject to be solved.

### SUMMARY OF THE INVENTION

Pursuant to the above problem, an objective of the invention is to provide a network device and a method for controlling QoS that can improve the QoS in transmitting video or voice signals on a network.

Another objective of the invention is to provide a network device and a method for controlling QoS that are not limited by the connection method or transmission format among networks so that they can effectively improve the QoS in video or voice signal transmission on a network.

A further objective of the invention is to provide a network device and a method for controlling QoS that uses hardware to control the QoS in network data transmissions so that the operation is simple, fast and provides a large data flow.

To achieve the above objectives, the disclosed network device includes a first connection port, a second connection port, a third connection port, and a QoS control device. The first connection port receives first class signals and the second connection port receives second class signals. When transmitting the second class signals, a higher QoS is required. The QoS control device receives the first class signals and the second class signals transmitted from the first connection port and the second connection port, respectively, and allows the first class signals to pass first when both the first class signals and the second class signals reach the QoS control device at the same time. The third connection port outputs the first class signals and the second class signals from the network device.

The invention also discloses a method for controlling the QoS. The method receives first class signals through a first connection port and second class signals through a second connection port, where the second class signals have a higher priority than the first class ones. Through the control of a quality-of-service control device, the second class signals pass with a higher priority. Finally, both the first class signals and the second class signals are output through a third connection port.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing a QoS controlled network device according to a preferred embodiment of the invention;

FIG. 2(A) is a schematic view showing the connection among the disclosed QoS controlled network device, a LAN, a WAN, and a telephone device;

FIG. 2(B) is another schematic view showing the connection among the disclosed QoS controlled network device, a LAN, a WAN, and a telephone device; and

FIG. 3 is a flowchart showing the procedure of a QoS control method according to a preferred embodiment of the invention.

In the various drawings, the same references relate to the same elements.

### DETAILED DESCRIPTION OF THE INVENTION

The disclosed network device for controlling QoS (quality of service) will be apparent from the following detailed description, which proceeds with reference to the accompanying drawings, wherein the same reference numbers relate to the same elements.

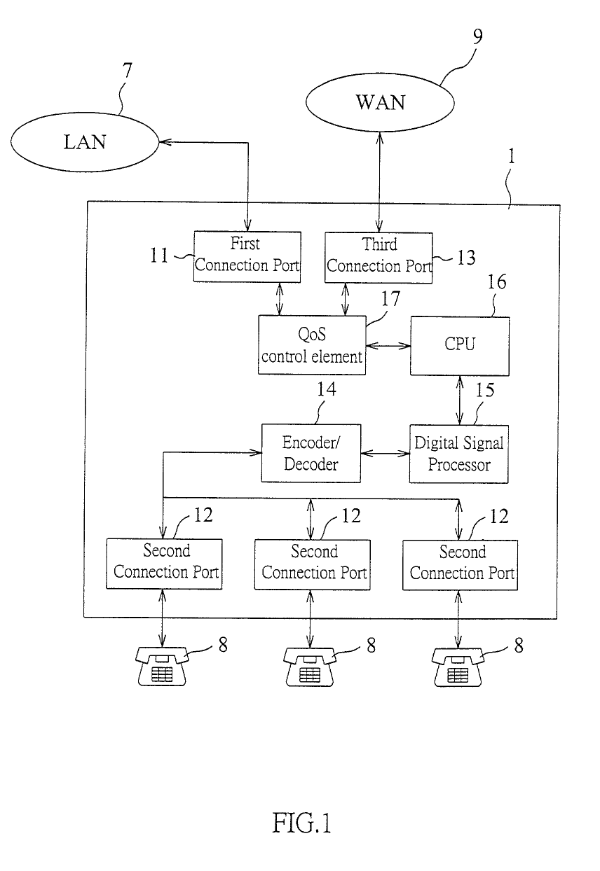

Referring to FIG. 1, the disclosed network device 1 has three connection ports, namely, a first connection port 11, a second connection port 12 and a third connection port 13. The first connection port receives first class signals, the second connection port receives second class signals, and the third connection port 13 transmits signals output from the network device 1. The difference between the first class signals and the second class signals is in that the second class signals (such as voice or video signals) have a higher requirement in the QoS than the first class ones (which are data packets). For example, if the QoS in network transmissions is low when transmitting voice signals through a network, the receiver will experience significant signal delays. However, transmitting usual data packets through a network does not require such a high QoS. In these situations, the data packets are considered as the first class signals while the voice signals the second class ones.

In the current embodiment, the first connection port 11 receives the data packets sent from a LAN (Local Area Network) 7. The first connection port 11 can be a serial connection port in an Ethernet. The second connection port 12 receives analog voice signals transmitted from a telephone device 8. The second connection port 12 can be an SLIC (Subscriber Line Interface Circuit) device. The third connection port 13 connects to a WAN (Wide Area Network) 9 and can use, for instance, a coaxial cable connector.

When the second connection port 12 receives analog voice signals, it immediately sends them to an encoder/decoder 14 to convert the analog voice signals into digital voice signals. The digital voice signals are compressed into a digital voice data packet in a digital signal processor 15. The digital signal processor 15 can perform such functions as gain control, tone detection and echo cancellation.

A CPU (Central Processing Unit) 16 performs data capsulation on the digital voice data packet, e.g. adding the header information to the digital voice data packet. Afterwards, the digital voice data packet is sent to a QoS control element 17.

The QoS control element 17 receives the data packets from the first connection port 11 and the digital voice data packets from the second connection port 12 and sends the received signals to the third connection port 13, which then send them to the WAN 9. When the two classes of signals are received at the same time, the QoS control element 17 can use the following determination method to allow the digital voice data packets to pass first:

The QoS control element 17 can allow the digital voice data packets to pass first according to the priority of the ports. That is, when signals from the second connection port 12 are received, they automatically gain the highest priority to be processed.

Also, the QoS control element 17 can let the digital voice data packets pass first according to the TOS (type of service) definition item in the headers. That is, the QoS control element 17 can check the item value that defines the TOS in the header of the TCP/IP packet. When the item value indicates that the packet is a digital voice data packet or a data packet that has a higher QoS requirement, the packet is processed first so as to reduce its delay.

Alternatively, the QoS control element 17 can let the digital voice data packets pass first according to the contents of a VLAN (Virtual Local Area Network) tag. Sometimes, certain devices do not support the mechanism for processing IP TOS definition items but do support the VLAN tags.

Therefore, the processing priority of the digital voice data packet is higher than the data packet in the QoS control element 17. When the QoS controlled network device 1 receives both the digital voice data packet and the data packet at the same time, the former can quickly pass through without significant delay.

The method of determining the processing priority of packets in the QoS controlled network device 1 can be programmed according to practical needs. For example, one can use a computer that has a browser to set the QoS control element 17 in the network device 1 so that the QoS control element 17 allows the digital voice data packets to pass first according to the TOS definition item in the headers when it is used with network equipment that supports the header formats. When it is used with network equipment that does not support the header formats, it lets the digital voice data packets pass first according to the contents of the VLAN tags or the port priorities. Thus, the disclosed network device 1 can be used with different kinds of network equipment.

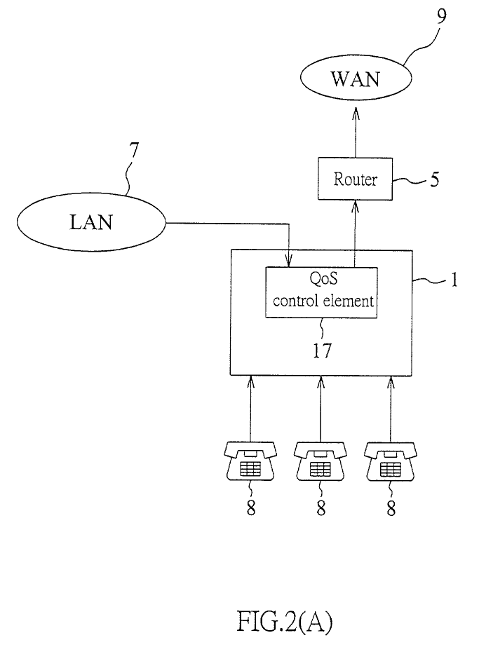

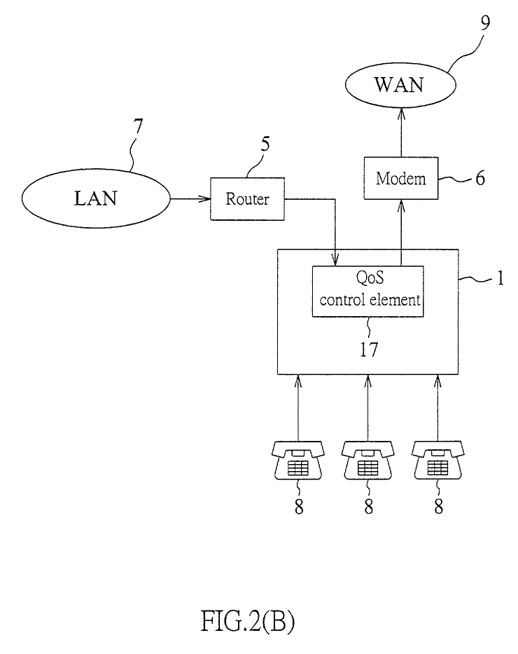

With reference to FIG. 2(A), the QoS controlled network device 1 according to a preferred embodiment can be used with a LAN 7 and a telephone device 8 so as to connect to a WAN 9 through a router 5. Data packets and digital voice data packets can be transmitted via the same circuit. Furthermore, through the control of the QoS controlled network device 1, the transmission QoS of voice signals can be enhanced, greatly reducing the delays or interruptions due to the simultaneous transmissions of voice signals and data packets.

With reference to FIG. 2B, the disclosed QoS controlled network device 1 can connect to a LAN 7, a telephone device 8 and a WAN 9 via a router 5 and a modem 6. In other words, the network device 1 would not be limited by the connection method among networks. The user can easily insert the network device 1 under the original network structure to enhance the voice signal transmission QoS.

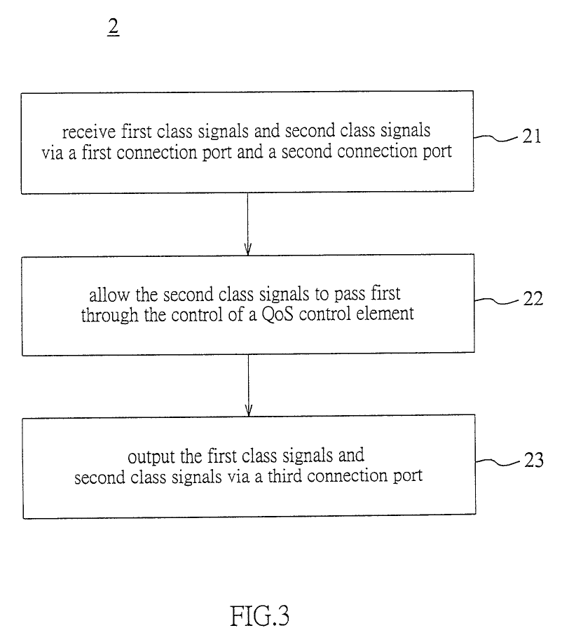

As shown in FIG. 3, the QoS control method 2 according to a preferred embodiment receives first class signals and second class signals via a first connection port and a second connection port, respectively, in a receiving step 21. Through the control of a QoS control element, the second class signals are allowed to pass first in a QoS control step 22. In an output step 23, the first class signals and the second class signals are output via a third connection port. Since the relevant devices mentioned in the method have been described in detail before, they are not further explained here.

Since the disclosed QoS controlled network device and the QoS control method are not limited by the connection method among networks, they can simply and effectively improve the transmission QoS under the original network structure.

Since the disclosed QoS controlled network device and the QoS control method use hardware to perform the network transmission QoS control, it has the advantages of simple operation, fast speed and large data flow.

Since the disclosed QoS controlled network device and the QoS control method can process any data transmission format, it can thus integrate various types of network systems. This can greatly reduce the cost of setting up and maintaining a network and also increase the efficiency of the network usage.

It should be emphasized that any person skilled in the art can make equivalent modification of the invention without departing from its spirit and scope. For example, the second connection port can receive video signals taken by a video camera and the corresponding encoder/decoder and digital signal processor can be modified to process video signals. Moreover, one can design a connection port that receives digitized video signals and transmits the signals directly to the QoS control element without the need to be processed by the encoder/decoder and digital signal processor.

Certain variations would be apparent to those skilled in the art, which variations are considered within the spirit and scope of the claimed invention.

What is claimed is:

1. A network with QoS (Quality of Service) control, which comprises:
a first connection port for receiving first class signals;
a second connection port for receiving second class signals which require a higher transmission priority than the first class signals;
a QoS control element, which receives the first class signals and the second class signals transmitted from the first connection port and the second connection port, respectively; and
a third connection port, which outputs the first class signals and the second class signals.

2. The network device of claim 1, wherein the QoS control element allows the second class signals to pass first according to port priorities.

3. The network device of claim 1, wherein the QoS control element allows the second class signals to pass first according to a TOS (Type Of Service) definition item.

4. The network device of claim 1, wherein the QoS control element allows the second class signals to pass first according to a VLAN (Virtual Local Area Network) tag.

5. The network device of claim 1, wherein the first connection port connects to a LAN.

6. The network device of claim 1, wherein the second connection port connects to at least one telephone device.

7. The network device of claim 1, wherein the third connection port connects to a WAN.

8. The network device of claim 1, wherein the first class signal is a data packet.

9. The network device of claim 1, wherein the second class signal received by the second connection port is an analogue voice signal.

10. The network device of claim 9, wherein the second class signal received by the QoS control element is a digital voice data packet that is converted from the analogue voice signal.

11. The network device of claim 9 further comprising:
an encoder/decoder for converting the analogue voice signal into a digital voice signal;
a digital signal processor for compressing the digital voice signal into a digital voice data packet; and
a CPU for encapsulating the digital voice data packet.

12. A network device with QoS control, which comprises:
a first connection port, which connects to a LAN and receives a data packet;
a second connection port, which connects to a telephone device and receives an analogue voice signal;
an encoder/decoder, which converts the analogue voice signal into a digital voice signal;
a digital signal processor, which compresses the digital voice signal into a digital voice data packet;
a CPU, which encapsulates the digital voice data packet;
a QoS control element, which receives the digital voice data packet and the data packet and allows the digital voice data packet to pass first when the digital voice data packet and the data packet are received simultaneously; and
a third connection port, which outputs the digital voice data packet and the data packet.

13. The network device of claim 12, wherein the QoS control element allows the digital voice data packet to pass first according to port priorities.

14. The network device of claim 12, wherein the QoS control element allows the digital voice data packet to pass first according to a TOS definition item.

15. The network device of claim 12, wherein the QoS control element allows the digital voice data packet to pass first according to a VLAN tag.

16. A QoS control method, which comprises the steps of:
receiving a first class signal via a first connection port;
receiving a second class signal that requires a higher QoS than the first class signal via a second connection port;
allowing the second class signal to pass first through the control of a QoS control element; and
outputting the first class signal and the second class signal via a third connection port.

17. The method of claim 16, wherein the QoS control element allows the second class signals to pass first according to port priorities.

18. The method of claim 16, wherein the QoS control element allows the second class signals to pass first according to a TOS (Type Of Service) definition item.

19. The method of claim 16, wherein the QoS control element allows the second class signals to pass first according to a VLAN tag.

20. The method of claim 16, wherein the first class signal is a data packet.

21. The method of claim 16, wherein the second class signal received by the second connection port is an analogue voice signal.

22. The method of claim 21, wherein the second class signal received by the QoS control element is a digital voice data packet converted from the analogue voice signal.
